(19) United States
(12) Patent Application Publication
(10) Pub. No.: US 2008/0142488 A1
(43) Pub. Date: Jun. 19, 2008

(54) COMPOUND ELECTRODE, METHODS OF MANUFACTURE THEREOF AND ARTICLES COMPRISING THE SAME

(75) Inventors: Yuanfeng Luo, Shanghai (CN); Garth M. Nelson, Ballston Lake, NY (US); Ugo Cantelli, Rome (IT); Renwei Yuan, Shanghai (CN); Yimin Zhan, Shanghai (CN); Enzo Nocciolini, Sesto Fiorentino (IT)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/612,653

(22) Filed: Dec. 19, 2006

(51) Int. Cl. B23H 1/00; B23H 1/06

(52) U.S. Cl. 219/69.15

(57) ABSTRACT

Disclosed herein is a compound electrode comprising a first portion comprising graphite; and a second portion comprising a metal; wherein the first portion is in continuous communication with the second portion along a length of the compound electrode. Disclosed herein too is a compound electrode comprising a first portion comprising graphite; and a second portion comprising a metal; wherein the first portion is in a tight fit with the second portion along a length of the compound electrode. Disclosed herein is a method comprising creating an electric arc between a compound electrode and a workpiece; wherein the compound electrode comprises a first portion comprising graphite; and a second portion comprising a metal; wherein the first portion is in a tight fit with the second portion along a length of the compound electrode; and removing a portion of the workpiece.

### BACKGROUND

This disclosure relates to a compound electrode, methods of manufacture thereof and articles comprising the same. In particular, this disclosure relates to a compound electrode for electrical discharge machines.

Electrical discharge machining (or EDM) is a machining method that is generally used for machining hard metals or those that would be impossible to machine with other techniques such as using lathes, drills, or the like. One limitation, however, is that EDM only works with materials that are electrically conductive. EDM can cut small or odd-shaped angles, intricate contours or cavities in extremely hard steels and other hard metals such as titanium, hastelloy, kovar, inconel, carbide, or the like, or a combination comprising at least one of the foregoing electrically conductive materials.

Sometimes referred to as spark machining or spark eroding, EDM offers a method of removing materials by a series of rapidly recurring electric arcing discharges between an electrode (the cutting tool) and the workpiece, in the presence of an energetic electric field. The EDM cutting tool is guided along the desired path very close to the work but it does not touch the piece. Consecutive sparks produce a series of micro-craters on the workpiece and remove material along the cutting path by melting and vaporization. The workpiece forms the cathode and the tool, otherwise referred to as the electrode, forms the anode. The particles are washed away by the continuously flushing dielectric fluid. There are two main types of EDM machines, ram and wire-cut machines.

FIG. 1 illustrates an electric sparking drill for drilling one or more holes in a workpiece 10 utilizing an electrode 12. A voltage V_{g} is applied across the electrode 12 and a base 14, supporting the workpiece 10. The applied voltage V_{g}, a gap 16′, and the resistivity of the liquid 18 supplied from tank 20 determine whether arcing occurs between the electrode 12 and the workpiece 10 in order to machine a hole in the workpiece 10. The combination of parameters including at least the voltage of V_{g}, the gap 16′, and the resistivity of the liquid 18 may result in a desirable arcing condition or two undesirable conditions, an open circuit or a short circuit. The liquid 18 is pumped via pump 22 into the gaps 16 and 16′. Arcing generally only occurs at the end of the electrode 12 at gap 16′, in order to efficiently machine the hole in workpiece 10. Arcing on the sides of the electrode 12 at gap 16 is undesirable and degrades the efficiency and speed with which the workpiece 10 may be machined. The liquid 18 is de-ionized or pure water having a high resistivity of about 100,000 to about 1,000,000 ohm-centimeters. The pump 22 supplies the liquid 18 at a pressure of approximately 50 bar and at a flow rate of about 60 to about 100 cubic centimeters per minute. The voltage V_{g} is supplied using a DC current source 24, a switching element 26, a current limiting resistor 28, a pulse generator 30, amplifiers 32 and 34, a mean voltage controller 36, a reference voltage Vᵣ and a feedback voltage V_{f}. In general, the DC source 24 supplies a voltage on the order of four to six times the arcing voltage Vₐ.

The pump 22 supplies the liquid 18 via a high pressure joint 23. The amplifier 34 supplies a voltage to the motor M_{z}. The motor M_{z} controls the position of the electrode in the z-axis as illustrated in FIG. 1. The motor M_{z} controls the speed at which the electrode 12 revolves. The feedback voltage V_{f} is supplied via a brush contact 38.

When the voltage across the gap V_{g} reaches a predetermined level, an electric sparking drill or arc is formed across the gap 16′. As a result, the arc passes from the electrode 12 and terminates on the workpiece 10, creating a high temperature explosion at the workpiece 10, thus causing the workpiece 10 surface to decompose. Generally, the surface is melted and dispersed as re-solidified chips that are retained in the gap 16′. Due to a pumping action of the electrode 12 caused by a periodic up-and-down “jump” of the electrode 12, the liquid 18 washes most of the chips out of the gap 16′.

Electrodes are generally manufactured from conductive materials such as graphite, brass, or copper. As noted above, a flow of dielectric fluid, such as a hydrocarbon oil, is pumped into the gap between the electrode and the workpiece to allow a path for the electrical discharge and to flush away debris from the arcing. A pulsating dc power supply is connected to supply the energy that provides the arcing between the electrode and the workpiece. The discharges travel through and ionize the dielectric fluid and sparks occur where the surfaces of the electrode and the workpiece are closest. The region in which the spark occurs is heated to such high temperatures that a small speck of the work surface is melted and removed from the workpiece, and is subsequently swept away by the flow of the dielectric fluid. This part of the workpiece is now below the average level of the workpiece surface so the next highest areas of the workpiece are removed next. These discharges occur hundreds or thousands of times per second so that gradually all of the area on the workpiece that is in communication (via electrical discharge) with the electrode is eroded.

EDM can be used to machine virtually any material, as long as it is a relatively good conductor of electricity. These include metals, alloys and carbides, which are too hard or delicate to machine by conventional methods. The melting point, hardness or brittleness of the material does not affect the process and the tool does not have to be harder than the workpiece, as no physical contact occurs between the two. Hence EDM is capable of repeatedly machining complex shapes in already hardened and stabilized materials. In addition, as no mechanical force is applied to the workpiece, very delicate and fragile components can be produced without distortion of the workpiece. Furthermore, good surface finishes are also readily attainable and EDM is capable of producing components with extremely fine finishes to precision tolerances measured in ten thousands of an inch.

For these reasons and the other advantages previously mentioned, EDM is used to machine components for use in aeronautical and space applications. For example, EDM is used to machine cooling holes in super alloy components of gas turbine airfoils in circumstances where accessibility or hole shape complexity precludes the use of laser drilling. Cooling holes are formed in the airfoil wall sections of nozzle guide vanes to enable cooling air fed, for example, from the engine compressor to pass from the hollow core of the nozzle guide vanes to form a thin film of cooling air over the airfoil surface, thereby protecting the airfoil from the effects of high temperature combustion gases. One drawback to the machining process is that since the electrodes are used to machine different thickness of component material, the electrodes wear at different rates. Occasionally one or more electrodes will fail to break out the other side of the component being machined, due either to the electrode breaking or becoming welded to the component, thereby resulting in incomplete machining of a hole through the material.

Currently, damage to an electrode and therefore incomplete machining is only detected if manual inspection of the machined component reveals an incompletely machined hole. By this time in the process, several components may have been incompletely machined. This is clearly undesirable, as the incompletely machined components will need to be re-entered into the EDM process, re-aligned with the EDM cartridge and re-machined. This adds to both the time and cost of the production process. When an electrode is easily worn, more time will be exhausted in changing the tool (or electrode), which will affect the over all cycle time. Generally, when using EDM processes, it is desirable to estimate the number of components an electrode or a set of electrodes can machine before the electrodes need replacing. The desire to err on the side of caution, in order to minimize the risks of incorrectly machined components due to electrode wear and/or damage, leads to continuous wastage of extremely expensive electrodes.

It is therefore desirable to manufacture electrodes from materials that do not wear or break easily and hence permit cost effective manufacturing processes.

### SUMMARY

Disclosed herein is a compound electrode comprising a first portion comprising graphite; and a second portion comprising a metal; wherein the first portion is in continuous communication with the second portion along a length of the compound electrode.

Disclosed herein too is a compound electrode comprising a first portion comprising graphite; and a second portion comprising a metal; wherein the first portion is in a tight fit with the second portion along a length of the compound electrode.

Disclosed herein is a method comprising creating an electric arc between a compound electrode and a workpiece; wherein the compound electrode comprises a first portion comprising graphite; and a second portion comprising a metal; wherein the first portion is in a tight fit with the second portion along a length of the compound electrode; and removing a portion of the workpiece.

### BRIEF SUMMARY OF FIGURES

FIG. 1 illustrates an electric sparking drill for drilling one or more holes in a workpiece utilizing an electrode;

FIG. 2 is a schematic diagram illustrating one exemplary embodiment of a compound electrode;

FIG. 3(a) depicts one exemplary arrangement wherein the outer surface of the first portion is concentric to the inner surface of the second portion of the compound electrode. FIG. 3(a) is taken along section AA′ of the FIG. 2;

FIG. 3(b) represents an isometric view of the compound electrode depicted in the FIG. 3(a);

FIG. 3(c) depicts a cross-sectional view of the compound electrode wherein the first portion and the second portion share the same outer circumference;

FIG. 3(d) represents an isometric view of the compound electrode of FIG. 3(c);

FIG. 3(e) depicts another cross-sectional view of the compound electrode wherein the first portion and the second portion share the same outer circumference;

FIG. 3(f) represents an isometric view of the compound electrode of FIG. 3(e);

FIG. 4(a) depicts another exemplary arrangement wherein the outer surface of the first portion is disposed to be concentric to the inner surface of the second portion of the compound electrode;

FIG. 4(b) represents an isometric view of the compound electrode depicted in the FIG. 4(a);

FIG. 5 is a schematic diagram wherein the first portion and the second portion may be disposed to be in communication with one another along only a portion of the total length of the compound electrode;

FIG. 6(a) represents a front view of the compound electrode 200 that is depicted in the FIG. 5;

FIG. 6(b) represents an isometric view of the compound electrode of FIG. 5;

FIG. 6(c) represents a transparent isometric view of the compound electrode. It provides details of how communication between the first portion and the second portion is accomplished; and

FIG. 7(a) represents a cross-sectional view wherein the outer diameter of the second portion is be larger than the outer diameter of the first portion;

FIG. 7(b) represents an isometric view wherein the outer diameter of the second portion is be larger than the outer diameter of the first portion; and

FIG. 8 depicts one manner of using the electrode.

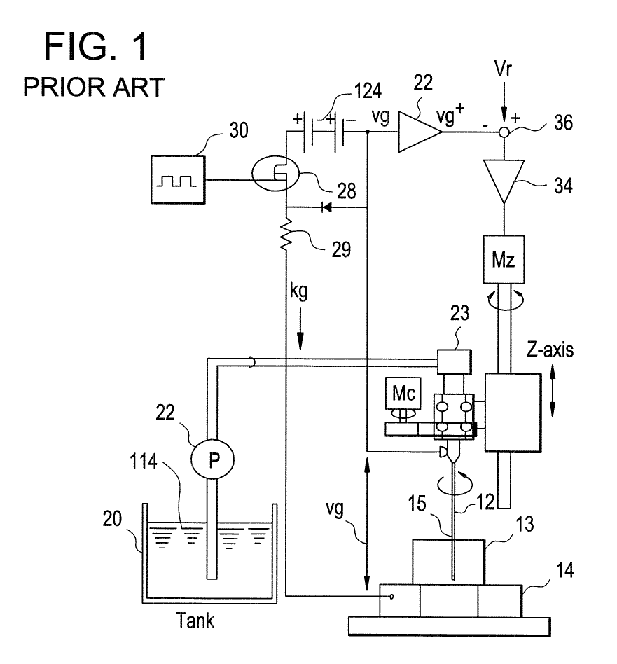

### DETAILED DESCRIPTION

The use of the terms “a” and “an” and “the” and similar references in the context of describing the invention (especially in the context of the following claims) are to be construed to cover both the singular and the plural, unless otherwise indicated herein or clearly contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. The terms “inner surface” and “outer surface” are used herein in reference to tubular devices that have circular cross-sectional areas. As used herein, in reference to tubular devices, an inner surface will always have a smaller diameter than the corresponding outer surface for a given circular section.

Disclosed herein is a compound electrode that can be used in electro-discharge machining (EDM). In an exemplary embodiment, the compound electrode can be used for electroerosion. The compound electrode comprises a first portion that comprises graphite and a second portion that comprises a metal. In one embodiment, the first portion and the second portion are disposed to be in intimate contact with one another along the entire length of the electrode. In another embodiment, the first portion and the second portion are disposed to be in contact with one another along only a portion of the length of the electrode. The compound electrode displays advantages of greater rigidity and lower tooling wear thereby resulting in greater efficiency and reduced costs during machining.

The compound electrode can also advantageously be used for electro-discharge machining of blisk airfoils. In the machining of blisk airfoils, the cycle time for the electro-discharge machining is reduced by an amount of greater than or equal to about 10%, specifically greater than or equal to about 20%, and more specifically greater than or equal to about 30% over similar electro-discharge machining processes where the compound electrode is not used. In another embodiment, during the machining of blisk airfoils, the electrode wear is reduced by an amount of greater than or equal to about 5%, specifically greater than or equal to about 10%, and even more specifically greater than or equal to about 20%, over comparative commercially available electrodes.

In yet another embodiment, the electrical resistivity of the compound electrode is reduced in an amount of greater than or equal to about 10%, specifically reduced in an amount of greater than or equal to about 20%, more specifically reduced in an amount of greater than or equal to about 30%, and even more specifically reduced in an amount of greater than or equal to about 40% over a comparative electrode consisting only of graphite. In an exemplary embodiment, the compound electrode displays this decrease in electrical resistivity when the electrode has a length greater than or equal to about 300 millimeters, specifically greater than or equal to about 350 millimeters, more specifically greater than or equal to about 400 millimeters, and even more specifically greater than or equal to about 450 millimeters.

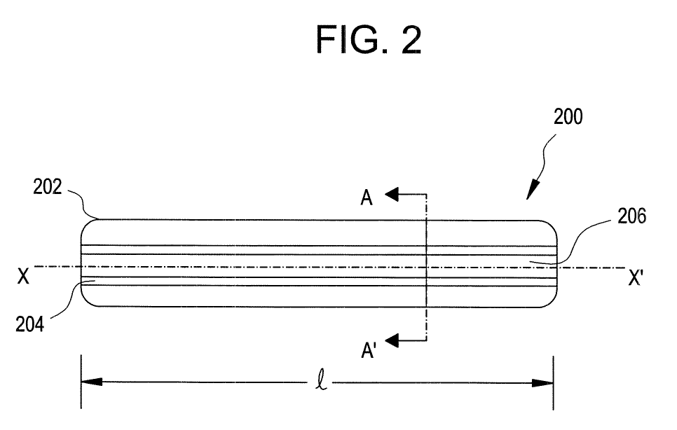

The compound electrode can be a solid or a tubular electrode. The compound electrode can have a cross-sectional area that is circular, triangular, square, rectangular, polygonal or a combination comprising at least one of the foregoing cross-sectional areas. Electrodes having the foregoing cross-sectional area geometries can exist in tubular form as well (e.g., an electrode having a triangular cross-sectional area can have a hole disposed in the triangular cross-sectional area). FIG. 2 illustrates one exemplary embodiment of a tubular compound electrode 200. The compound electrode comprises a first portion 202 that comprises graphite and a second portion 204 that comprises a metal. A hole 206 extends throughout the length of the electrode. In one embodiment, the second portion 204 comprises a plurality of metals in the form of an alloy. Examples of suitable metals that can be used in the second portion 204 are brass, copper, stainless steel, carbon steel, aluminum, or the like, or a combination comprising at least one of the foregoing metals.

In one embodiment, the first portion 202 may comprise a solid piece of graphite that is machined to the desired shape. Solid pieces of graphite are commercially available from Ashbury Graphite, Poco Graphite, Tokai Carbon Company Ltd., or Graphite Engineering Co.

In another embodiment, the first portion 202 may be manufactured from a moldable composition comprising powdered graphite and a binder. Graphite employed in the moldable composition may be synthetically produced or naturally produced. There are three types of naturally produced graphite that are commercially available. They are flake graphite, amorphous graphite and crystal vein graphite.

Flake graphite, as indicated by the name, has a flaky morphology. Flake graphite generally has a carbon concentration of about 5 to about 40 wt % based on the flake composition. Amorphous graphite is not truly amorphous as its name suggests but is actually crystalline. Amorphous graphite is available in average sizes of about 5 micrometers to about 10 centimeters. Crystal vein graphite generally has a vein like appearance on its outer surface from which it derives its name. Crystal vein graphite is commercially available in the form of flakes from Asbury Graphite and Carbon Inc.

Synthetic graphite can be produced from coke and/or pitch that are derived from petroleum or coal. Synthetic graphite is of higher purity than natural graphite, but not as crystalline. One type of synthetic graphite is electro-graphite, which is produced from calcined petroleum coke and coal tar pitch in an electric furnace. Another type of synthetic graphite is produced by heating calcined petroleum pitch to 2800° C. Synthetic graphite tends to be of a lower density, higher porosity, and higher electrical resistance than natural graphite.

Graphite in the form of carbon nanotubes can also be used in the moldable composition. The carbon nanotubes can be single wall carbon nanotubes, multiwall carbon nanotubes, vapor grown carbon fibers or a combination comprising at least one of the foregoing carbon nanotubes.

It is desirable to use graphite having average particle sizes of about 1 to about 5,000 micrometers. Within this range, graphite particles having average particle sizes of greater than or equal to about 3, specifically greater than or equal to about 5 micrometers may be advantageously used. Also desirable are graphite particles having sizes of less than or equal to about 4,000, specifically less than or equal to about 3,000, and more specifically less than or equal to about 2,000 micrometers. Graphite (with the exception of carbon nanotubes) is generally flake like with an aspect ratio greater than or equal to about 2, specifically greater than or equal to about 5, more specifically greater than or equal to about 10, and even more specifically greater than or equal to about 50.

The graphite is generally used in amounts of greater than or equal to about 40 wt % to about 95 wt % of the total weight of the moldable composition. Within this range, graphite is generally used in amounts greater than or equal to about 13 wt %, specifically greater or equal to about 15 wt %, more specifically greater than or equal to about 18 wt % of the total weight of the moldable composition. Graphite is furthermore generally used in amounts less than or equal to about 90 wt %, specifically less than or equal to about 85 wt %, more specifically less than or equal to about 80 wt %, of the total weight of the moldable composition.

The binder is generally an organic polymer. Examples of suitable organic polymers are epoxies, phenolics, acrylic polymers, polysiloxanes, polyesters, polyimides, polyetherimides, polyolefins, polycarbonates, or the like, or a combination comprising at least one of the foregoing organic polymers.

The binder is present in the moldable composition in an amount of about 5 to about 60 wt %. Within this range, the binder is generally used in amounts greater than or equal to about 6 wt %, specifically greater or equal to about 8 wt %, more specifically greater than or equal to about 10 wt % of the total weight of the moldable composition. The binder is furthermore generally used in amounts less than or equal to about 55 wt %, specifically less than or equal to about 50 wt %, more specifically less than or equal to about 45 wt % of the total weight of the moldable composition.

The moldable composition is generally molded into the desired shape at a temperature that is greater than the flow temperature of the organic polymer. In one embodiment, the moldable composition can be melt blended in an extruder and then molded in an injection molding machine into the desired shape.

In yet another embodiment, the first portion 202 comprises a sintered composition that comprises graphite and metal particles. The graphitic particles are similar to those listed above. The metal particles can comprise the metals listed above (e.g., brass, copper, stainless steel, carbon steel, or the like). An exemplary metal is brass or copper.

In one embodiment, in one method of manufacturing the sintered composition, the graphite particles are first mixed with the metal particles in a blender to form a mixture. Exemplary blenders are Henschel mixers, Waring blenders, extruders, or the like. The mixture is then sintered at a composition that is generally greater than or equal to about the melting temperature of the metal. Pressures employed during sintering are sufficient to enable bonding between the blended particles.

In the embodiment depicted in the FIG. 2, the first portion 202 and the second portion 204 are disposed to be in continuous intimate contact with one another along the entire length of the compound electrode 200. As will be described later, the first portion 202 and the second portion 204 can alternatively be disposed to be in continuous intimate contact for only a part of the entire length of the compound electrode 200. The “length” of the electrode is defined as being a largest linear dimension that can be measured along a straight line drawn on a surface of the electrode. FIG. 2 indicates the length ‘1’ for the electrode. The length is generally measured along a surface that is parallel to the longitudinal axis XX′ of the electrode.

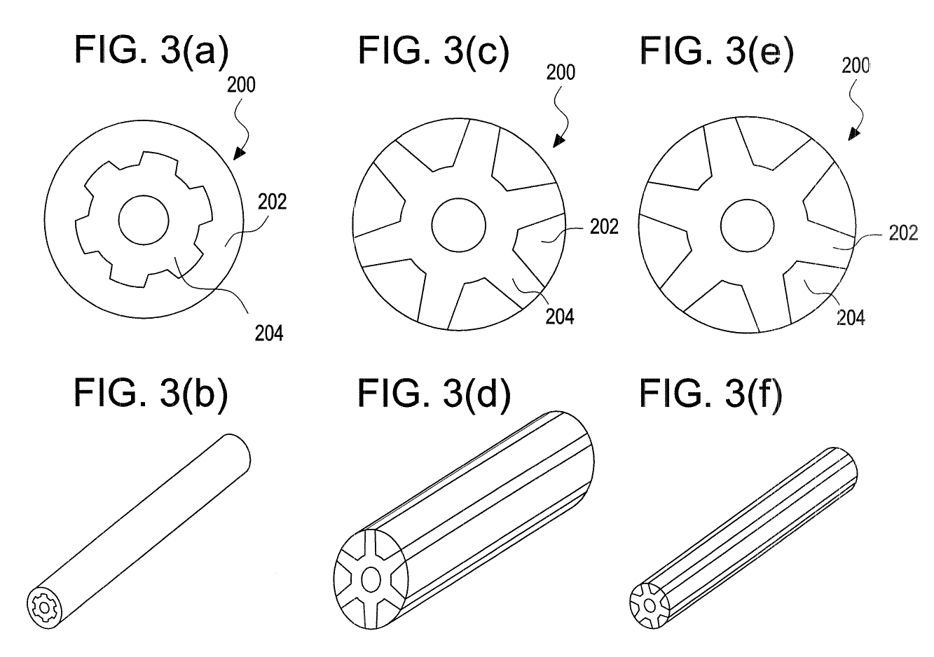

FIG. 2 represents a tubular electrode 200 wherein an outer surface of the first portion 202 is disposed to be concentric to the inner surface of the second portion 204. FIGS. 3(a) and (b) depicts one exemplary arrangement wherein the outer surface of the first portion 202 is concentric to the inner surface of the second portion 204 of the compound electrode 200. FIG. 3(a) represents the view taken along section AA′ of the FIG. 2. In this arrangement, the second portion 204 has splines disposed upon its outer surface that are mechanically engaged with opposing splines that are disposed upon an inner surface of the first portion 202. The opposing splines are frictionally engaged. This engagement of the opposing splines on the first portion 202 and the second portion 204 prevent relative motion between the first portion 202 and the second portion 204.

FIGS. 3(c), (d), (e) and (f) show additional exemplary embodiments where an outer surface of the first portion 202 is disposed to be concentric to the inner surface of the second portion 204. In the embodiments depicted in the FIGS. 3(c) and (d), the outer surface of the second portion 204 comprises splines that extend to the outer surface of the compound electrode 200. In the embodiments depicted in the FIGS. 3(e) and (f), the outer surface of the first portion 202 comprises splines that extend to the outer surface of the compound electrode 200.

As can be seen in the FIGS. 3(d) and 3 (f), the first portion 202 and the second portion 204 share a common outer circumference and are in contact along the entire length of the compound electrode 200. The first portion 202 and the second portion 204 are mechanically engaged via a friction fit, or by the use of an electrically conducting adhesive. In one embodiment, the outer diameter of the first portion 202 can be greater than an outer diameter of the second portion 204 or vice versa.

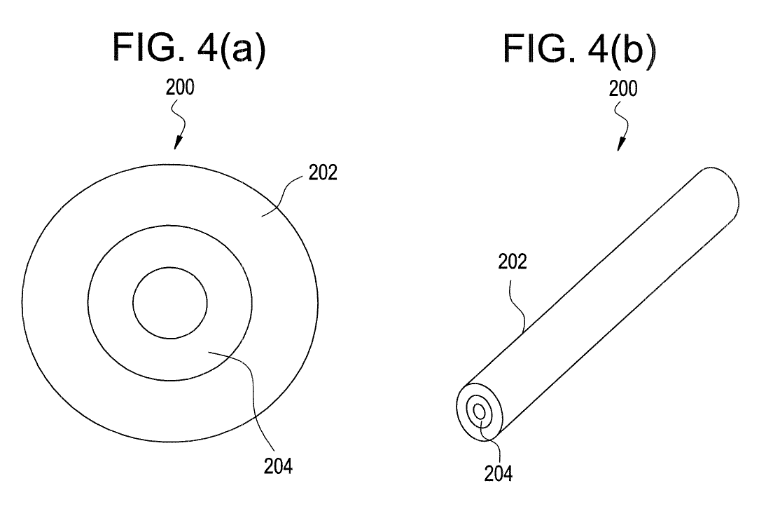

FIGS. 4(a) and (b) depicts another exemplary arrangement wherein the outer surface of the first portion 202 is disposed to be concentric to the inner surface of the second portion 204 of the electrode 200. In this exemplary arrangement, the inner and outer surface of the first portion 202 are concentric with one another while the inner and outer surface of the second portion 204 are concentric with one another.

It should be noted that it is also possible to have the arrangement depicted in the FIGS. 4(a) and (b) wherein the inner and outer surfaces of the first portion 202 and/or the second portion 204 are not concentric with one another. In other words, the longitudinal axis of the first portion 202 and the longitudinal axis of the second portion 204 do not coincide with one another i.e., they cannot be superimposed upon one another. In this embodiment, the respective longitudinal axes may be parallel to one another or can even intersect with one another if extended to infinity.

As can be seen in the FIGS. 4(a) and (b), the second portion 204 has an outer surface that is mechanically engaged with the inner surface of the first portion 202. In one embodiment, the second portion 204 has a substantially smooth outer surface that exists in a tight fit with a substantially smooth inner surface of first portion 202. In other words, the surfaces are frictionally engaged with one another because of the tight fit between the respective surfaces. In another embodiment, the respective surfaces may be textured to provide the frictional engagement between the first portion 202 and the second portion 204. In yet another embodiment, an electrically conductive adhesive may be used to bond the inner surface of the first portion 202 with the outer surface of the second portion 204.

The locations of the first portion 202 and the second portion 204 may also be reversed if desired. In other words, while the FIGS. 2, 3(a) and (b), and 4(a) and (b) depict a compound electrode having a graphite outer surface and a metal inner surface, it is possible for the inner surface to comprise graphite while the outer surface comprises a metal. Thus the first portion 202 can be disposed inside the second portion 204 and can be mechanically engaged with it as depicted in the FIGS. 3(a) and (b) as well as in FIGS. 4(a) and (b).

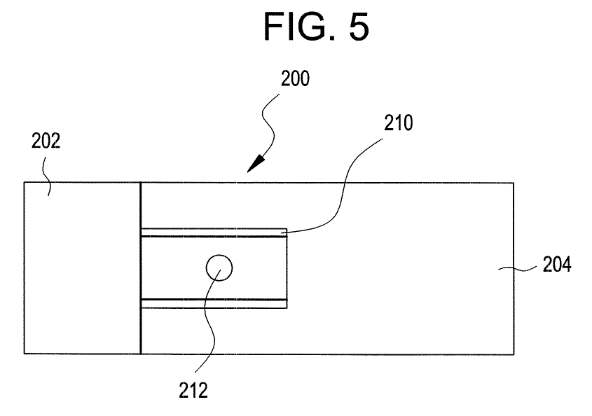

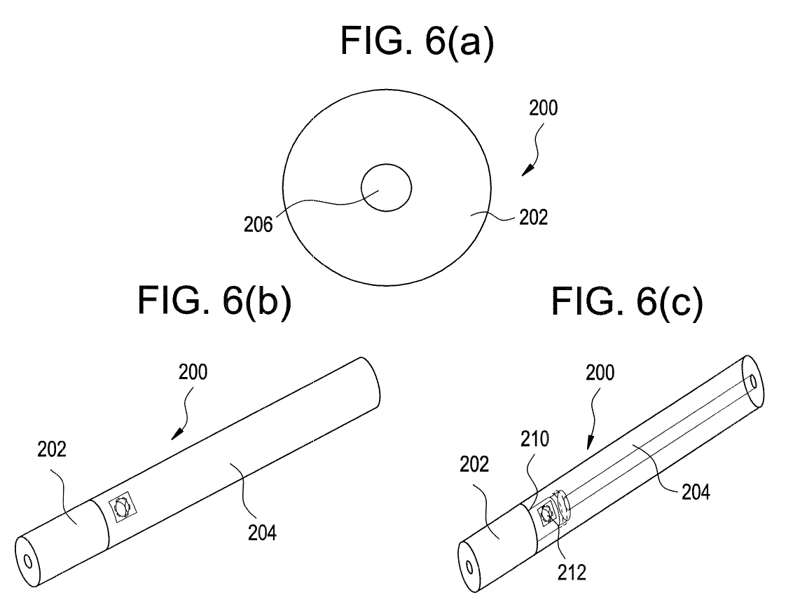

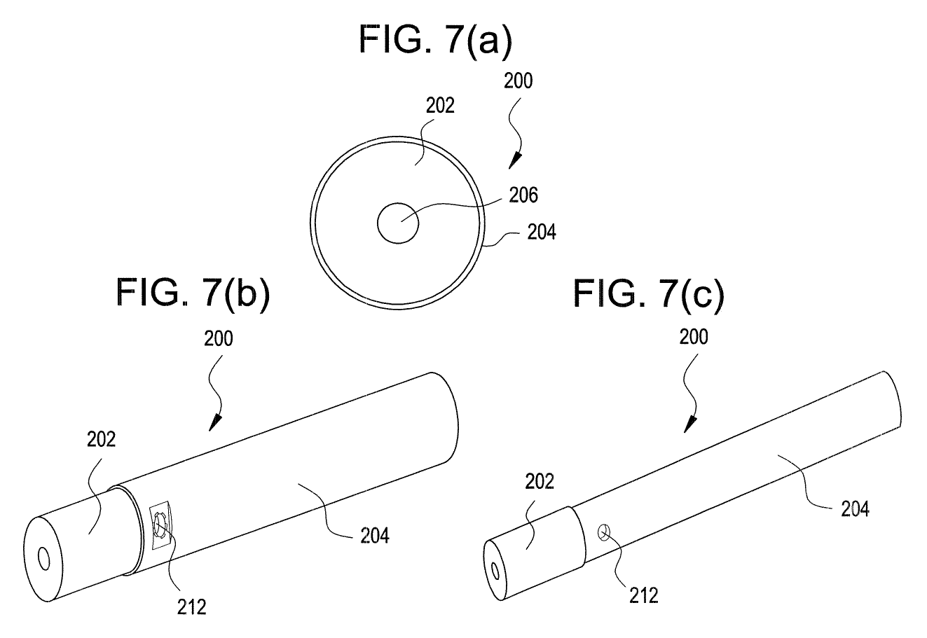

In yet another embodiment, as depicted in the FIG. 5, the first portion 202 and the second portion 204 may be disposed to be in communication with one another along only a portion of the total length of the compound electrode 200. Variations on this embodiment are depicted in the FIGS. 6(a), (b) and (c) as well as the FIGS. 7(a), (b) and (c) to be discussed later.

With reference now to the FIG. 5, the compound electrode can comprise one or more locking devices that can be used to mechanically engage the first portion 202 with the second portion 204. In one embodiment, the compound electrode can comprise a plurality of electrodes that can be used to mechanically engage the first portion 202 with the second portion 204. In the FIG. 4 the first portion 202 and the second portion 204 are locked in position by a first locking device 210 and a second locking device 212. Details of the respective locking devices are provided below. It is to be noted that the hole 206 is not depicted in the FIG. 4; however, the device may comprise the hole 206 if desired.

FIG. 6(a) represents a front view of the compound electrode 200 that is depicted in the FIG. 5 as well as in the FIGS. 6(b) and 6 (c). FIG. 6(b) represents an isometric view of the compound electrode 202, while FIG. 6(c) represents a transparent isometric view of the compound electrode 202 that provides details of how communication between the first portion 202 and the second portion 204 is accomplished.

In one embodiment depicted in the FIGS. 6(b) and (c), the first portion 202 and/or the second portion 204 can comprise a first locking device 210 that permits the first portion 202 and the second portion 204 to be mechanically engaged with one another while at the same time minimizing any relative motion between the first portion 202 and the second portion 204. In one embodiment, the locking device 210 comprises threads disposed on the outer surface of the first portion 202 and the inner surface 204 of the second portion that permits the respective portions to be mechanically engaged with each other. In this embodiment, a part of the outer surface of the first portion 202 and a part of the inner surface of the second portion are respectively threaded. The first portion 202 can then be screwed into the second portion 204.

In another embodiment depicted in the FIGS. 6(b) and (c), the first portion 202 and the second portion 204 can both comprise a first locking device 210, while the first portion 202 can also comprise a second locking device 212 that permit the first portion 202 and the second portion 204 to be mechanically engaged with each other. The second portion 204 can also optionally comprise the second locking device 212. In this embodiment, the first locking device 210 and the second locking device 212 are disposed to be inclined to each other at an angle “θ”. In other words, the direction of the locking force of the first locking device inclined at an angle to the direction of the locking force of the second locking device.

In an exemplary embodiment, depicted in the FIG. 6(c), the angle θ is 90 degrees. In this case, the second locking device 212 comprises a second set of threads disposed in the first portion 202. The locking device 212 can employ other devices such as for example, adhesives, rivets, bolts, nuts, screws, cotter pins, split pins, spring loaded cotter pins, or the like, or a combination comprising at least one of the foregoing locking devices.

In one exemplary manner of assembling the compound electrode as depicted in the FIGS. 6(b) and 6(c), the first portion 202 is first threaded into the second portion 204 using the first locking device 210, while a set screw (not shown) may be used to further lock the first portion 202 and the second portion 204 by engaging it with the second locking device 212.

In yet another exemplary embodiment, depicted in the FIGS. 6(a), (b) and (c) and 7(a), (b) and (c), the first locking device 210 can be a tight fit between the first portion 202 and the second portion 204 of the compound electrode. An additional optional second locking device 212 in the form of a set screw and threads (disposed in the first portion 202) can be used to prevent relative motion between the first portion 202 and the second portion 204 of the compound electrode. In the embodiments, depicted in the FIGS. 7(a), (b) and (c), the outer diameter of the second portion 204 can be larger than, equal to or less than the outer diameter of the first portion 202.

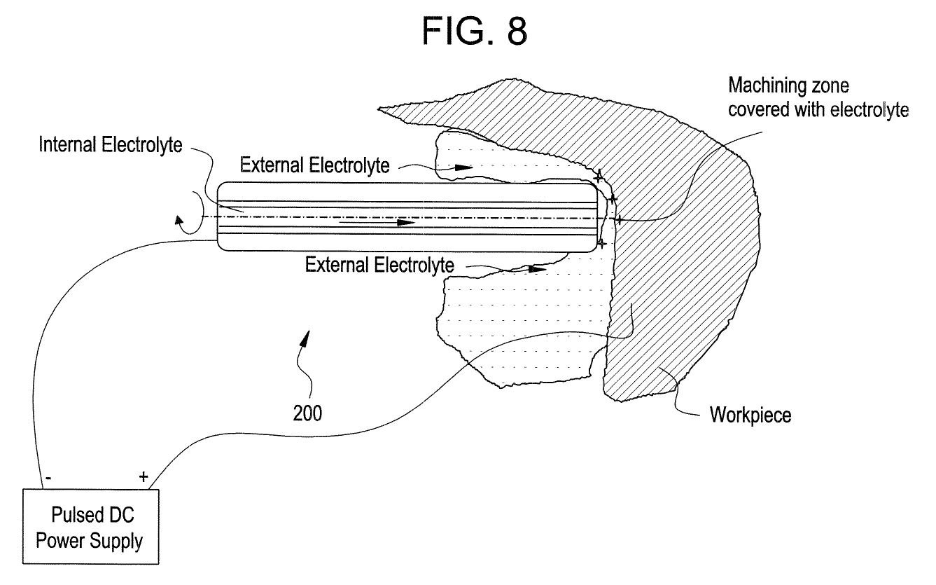

In one embodiment, in one manner of employing the compound electrode 200 to machine a workpiece, the compound electrode 200 is brought into the proximity of the workpiece and an electric arc created by the application of a suitable voltage between the electrode and the workpiece. FIG. 8 depicts one manner of using the electrode. A dielectric fluid is discharged between the workpiece to remove debris created as a result of the sparks between the compound electrode and the workpiece. The electrode may thus be used for the machining of workpieces. The use of the aforementioned locking devices permit the use of compound electrodes in machining of blisk airfoils. As noted above, the machining is accomplished with a reduction of over 30% in cycle time. The compound electrode also provides significant advantages in the machining of aeronautical components. These advantages comprise reduced wear, increase life spans, and reduced costs. As noted above, the compound electrode 200 can be used for electroerosion. In one embodiment, U.S. patent application No. 20050247569 to Lamphere et al. discloses electroerosion and the entire contents of this reference are hereby incorporated by reference.

In another embodiment, the compound electrode can be used to machine an aircraft engine case or to machine an impeller. When machining such devices with the compound electrode, the tooling wear can be reduced from 40% to less than 5%, especially when compared with a brass electrode. This can decrease the cycle time and reduce costs.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A compound electrode comprising:
a first portion comprising graphite; and
a second portion comprising a metal; wherein the first portion is in continuous communication with the second portion along a length of the compound electrode.

2. The compound electrode of claim 1, wherein the communication comprises a mechanical engagement of the first portion with the second portion.

3. The compound electrode of claim 2, wherein the first portion is mechanically engaged with the second portion along the entire length of the first portion or the entire length of the second portion.

4. The compound electrode of claim 2, wherein the first portion is mechanically engaged with the second portion along a part of an entire length of the first portion or a part of an entire length of the second portion.

5. The compound electrode of claim 1, wherein the first portion is in a tight fit with the second portion.

6. The compound electrode of claim 1, wherein the first portion and the second portion are mechanically engaged with each other via a locking device.

7. The compound electrode of claim 1, wherein the first portion and the second portion are mechanically engaged with each other via a plurality of locking devices.

8. The compound electrode of claim 6, wherein the locking device is operational to prevent relative motion between the first portion and the second portion.

9. The compound electrode of claim 1, wherein the first portion is tubular and wherein the second portion is tubular.

10. The compound electrode of claim 9, wherein the first portion has an outer surface that has a larger diameter than the diameter of the outer surface of the second portion.

11. The compound electrode of claim 9, wherein the first portion has an outer surface that has a smaller diameter than the diameter of the outer surface of the second portion.

12. The compound electrode of claim 1, wherein the first portion lies inside the second portion.

13. The compound electrode of claim 1, wherein the second portion lies inside the first portion.

14. The compound electrode of claim 1, wherein the first portion comprises a moldable composition that further comprises a binder; wherein the binder is an organic polymer.

15. The compound electrode of claim 1, wherein the first portion comprises a sintered composition that further comprises a powdered metal.

16. The compound electrode of claim 6, wherein the locking device comprises adhesive, rivets, bolts, nuts, screws, cotter pins, split pins, spring loaded cotter pins, or a combination comprising at least one of the foregoing locking devices.

17. The compound electrode of claim 1, wherein the metal comprises brass, copper, stainless steel, carbon steel, or a combination comprising at least one of the foregoing metals.

18. The compound electrode of claim 17, wherein the metal comprises brass, copper, stainless steel, carbon steel, aluminum, or a combination comprising at least one of the foregoing metals.

19. The compound electrode of claim 3, wherein the first portion and the second portion share a common outer circumference along an entire length of the compound electrode.

20. The compound electrode of claim 3, wherein the first portion and the second portion share a common outer circumference for a part of the length of the compound electrode.

21. The compound electrode of claim 3, wherein the first portion has a smaller diameter than the second portion for a part of the length of the compound electrode.

22. The compound electrode of claim 3, wherein the second portion has a smaller diameter than the first portion for a part of the length of the compound electrode.

23. A compound electrode comprising:
a first portion comprising graphite; and
a second portion comprising a metal; wherein the first portion is in a tight fit with the second portion along a length of the compound electrode.

24. The compound electrode of claim 23, wherein the first portion surrounds the second portion.

25. The compound electrode of claim 23, wherein the second portion surrounds the first portion.

26. The compound electrode of claim 23, wherein the first portion comprise splines and wherein the second portion comprises opposing splines; and
wherein the splines are mechanically engaged with each other.

27. The compound electrode of claim 23, wherein the first portion comprises an outer surface that is frictionally engaged with an inner surface of the second portion.

28. The compound electrode of claim 23, further comprising a locking device that minimizes relative motion between the first portion and the second portion.

29. The compound electrode of claim 23, wherein the compound electrode comprises a first locking device and a second locking device; wherein the direction of the locking force of the first locking device inclined at an angle to the direction of the locking force of the second locking device.

30. The compound electrode of claim 23, wherein the compound electrode is tubular in shape.

31. A method comprising:
creating an electric arc between a compound electrode and a workpiece;
wherein the compound electrode comprises a first portion comprising graphite; and a second portion comprising a metal; wherein the first portion is in a tight fit with the second portion along the length of the compound electrode; and
removing a portion of the workpiece.

32. The method of claim 31, comprising discharging a fluid between the electrode and the workpiece.

33. The method of claim 31, wherein the workpiece is a blisk airfoil, an engine casing, or a compressor impeller.
